(19) United States
(12) Patent Application Publication
(10) Pub. No.: US 2004/0088264 A1
(43) Pub. Date: May 6, 2004

(54) Automatic contract negotiation with multiple parameters

(76) Inventors: Christopher William Preist, Montpellier Bristol (GB); Andrew Robert Byde, Montpellier Bristol (GB); Claudio Bartolini, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/473,457

(22) PCT Filed: Apr. 11, 2002
(86) PCT No.: PCT/GB02/01706

(30) Foreign Application Priority Data
Apr. 11, 2001 (GB) 0109068.7
Jul. 27, 2001 (GB) 0118449.8

(51) Int. Cl. G06F 17/60

(52) U.S. Cl. 705/80

(57) ABSTRACT

A multi-parameter proposal is accepted by a proposal assessor which passes the initial proposal to a preference mapper which acts to reduce the number of parameters in the initial proposal. The negotiation is then carried out using a strategy designed to operate on the lower number of parameters. Counter proposals are expanded using the preference mapper so that counter proposals are expressed in substantially the same form as the incoming proposals.

This invention relates to methods and apparatus for performing automated negotiations.

With recent advances in the field of artificial intelligence, it has become possible to subordinate the task of contract negotiations to negotiating agents. Such agents interact with other agents acting on behalf of another potentially contracting party to settle the terms of a contract. Typically, such contracts concern the purchase of goods or services and the variables in the contract may for example be one of delivery timescales, cost and/or quality. Further, it will be appreciated that negotiations may be carried out in any situation where agreement must be reached about a particular value out of a range of values for one or more negotiation parameters.

The simplest prior art negotiating agents negotiate over a single parameter (most usually price). Thus much of the work performed hitherto has focussed on algorithms or strategies for single-parameter negotiations. Some work has been performed in the field of multi-parameter negotiations such as that set out In “Negotiation Decision Functions for Autonomous Agents”; Faratin, Sierra and Jennings; International Journal of Robotics and Autonomous Systems 1998. This paper describes time-bounded techniques which are used to concede different parameters simultaniously in a multiparameter negotiation. Each parameter (or “Issue” as termed in the paper) is negotiated separately so that effectively the multi-parameter negotiation occurs as a plurality of parallel single-parameter negotiations. Thus there is no coordinated interaction between the different parameters during negotiations.

A second approach to multi-parameter automated negotiation is set out in “A Multi-Attribute Utility Theoretic Negotiation Architecture for Electronic Commerce”; Barbuceanu and Low; pages 15-30, Proceedings of the Agent-Mediated Electronic Commerce Workshop, Barcelona 2000. The structure proposed in this paper uses multi-attribute utility theory to propose possible contracts in order of decreasing utility to the proposer. Only two negotiating parties are permitted and these parties provide proposals and counter proposals in order of decreasing utility until either the proposals intersect or both parties have no more counter proposals to offer.

In both cases, the algorithms are directed to two-party negotiations. Furthermore, both proposals have negotiating strategies permanently embedded. Thus although the strategies will not normally be explicitly revealed, it is possible (and understandably undesirable) that a third party may learn the strategy after several negotiations have occurred. If the strategy is learned then this may be exploited to gain advantage in the negotiations.

In accordance with a first aspect of the invention there is provided a method of negotiating comprising receiving a multi-parameter proposal expressed using a plurality of negotiable parameter values, processing the multi-parameter proposal using a predetermined mapping process to produce a single value representative of the plurality of negotiable parameter values, processing the said single value in accordance with a predetermined single parameter negotiating strategy, and returning the output of the single parameter negotiating strategy.

By mapping the multi-parameter proposal to a single value, it is possible to use a proven strategy based on the work which has already been carried out for single-strategy negotiations. Furthermore, by arranging for the processor processing the multi-parameter proposals to be a separable module (for example a separate software process) it is possible to alter the negotiating strategy in order to avoid discovery of the negotiating strategy and/or to adapt the negotiating method for alternative negotiating scenarios.

The negotiating strategy may also receive additional information directly (without passing through the preference map) about the negotiation such as a closing time for the negotiation. Proposals from competitors and other sources as well as trading partners may be passed through the preference mapper to be used by the negotiating strategy.

Preferably, also, the predetermined mapping process is a separable module. In this way, different mapping processes may be used for different types of negotiations having different numbers and types of negotiable parameters. Thus, in a typical supply of goods negotiation, the parameters may be price, delivery time and quality. Thus the mapping process for this type of negotiation will need to accept those three parameters. Alternatively, a negotiation may be carried out concerning provision of a telecommunications service of network in which the type of network is fixed. Thus the quality of the service may be specified by the type of network and therefore only two parameters (typically price and delivery time) are to be negotiated over. A different mapping process may well be desirable in such a situation.

It will be appreciated that the important attributes of the mapping process are that it can take many parameters and map them in a predetermined way to a single parameter.

If the single parameter negotiating strategy generates a counter proposal then in a preferred embodiment, the method also includes taking a single value representative of the counter proposal and processing the single value counter proposal to produce a multi-parameter counter proposal having a plurality of negotiable parameters which are equivalent to the plurality of negotiable parameters used to express the originally-received proposal. Thus the mapping process may be used to “unpack” a counter proposal so that it may be expressed to other negotiating parties in a multi-parameter format.

In accordance with a second aspect of the invention there is provided negotiating apparatus comprising a proposal assessor arranged to receive a multi-parameter proposal expressed using a plurality of negotiable parameter values, a preference mapper arranged to process the multi-parameter proposal using a predetermined mapping process to produce a single value representative of the plurality of negotiable parameter values, a strategy processor arranged to process the said single value in accordance with a predetermined single parameter negotiating strategy, and a negotiation output arranged to return the output of the strategy processor.

In a third aspect, the invention provides a proposal assessor arranged to receive a multi-parameter negotiation proposal expressed using a plurality of negotiable parameter values, the proposal assessor further comprising a mapping output arranged to output the multi-parameter proposal to a mapping means for mapping the multiparameter proposal to a single parameter proposal, a mapping input arranged to receive a single parameter proposal from the said mapping means, and a utility score output arranged to output a utility score representative of the multi-parameter proposal for processing by a single-parameter strategy process.

In a further aspect the invention provides a contour generator arranged to receive a single parameter negotiation proposal, the contour generator including a mapping output and a proposal input, the contour generator being further arranged to pass a received single parameter negotiation proposal to the mapping output and to receive an unpacked multi-parameter proposal representative of the single parameter proposal via the proposal input.

Embodiments of the invention will now be described with reference to the drawing in which

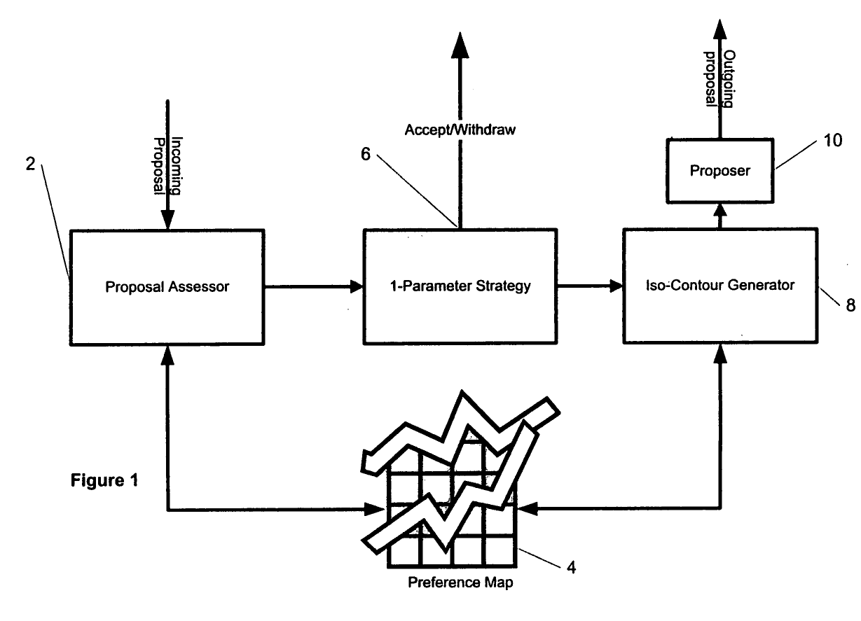

FIG. 1 is a schematic block diagram of negotiating apparatus in accordance with the invention.

The negotiation architecture set out below separates the strategy from the module dealing with the analysis of a multi-attribute proposal and counter proposal negotiation. The architecture also reduces the multi-parameter proposals to a single parameter which allows any single-parameter negotiation strategy to be used. This provides flexibility of the choice of strategy which therefore makes it harder for competitors to gain competitive advantage by second-guessing based on an expectation of the strategy in use. Furthermore, the strategy need not be a strategy designed for one-to-one negotiation. Instead the strategy may be a strategy designed for participating In a many-to-many market place.

With reference to the FIGURE, a proposal assessor receives an incoming proposal expressed as a plurality of negotiable parameters. For example, the proposal may take the form of a price value, a desired delivery time and a quality value. The proposal assessor 2 passes this multi-parameter proposal to a preference map 4.

The preference map is arranged to give a single value for every possible set of parameters the contract under negotiation can take. Thus, the preference map 4 returns a single parameter in response to the passing of a multi-parameter proposal from the proposal assessor. A suitable preference map is described in the applicants co-pending British Patent Application of even date entitled “Mapping Apparatus and Methods”, the contents of which are incorporated by reference herein.

The proposal assessor then passes the single parameter to the one-parameter strategy 6. The negotiating strategy 6 may be chosen to b suitable for the type of negotiation under contract. For example, the “bidding elf” may be used for an English auction, the “PS-agent” strategy may be used for a many-to-many market or the “time varied concession strategy” may be used for a one-to-one negotiation. The generic requirement for the one-parameter strategy is that it can accept a set of one-parameter offers (from potential trading partners and from competitors) and accept one or more or generate one or more new one-parameter counter offers.

The output of the strategy 6 will typically take one of three courses. Firstly, the strategy 6 may accept one of the proposals. The strategy may recognise that there are no further possible counter proposals and indicate withdrawal from the negotiation. The third option is that the strategy may issue one or more counter-proposals. A further option is to take no action and wait for further incoming proposals.

If a counter-proposal is generated this is fed to an iso-contour generator 8.

The iso-contour generator 8 unpacks the single value output by the one-parameter strategy using the preference map 4. The single value is unpacked to produce one or more equivalent multi-parameter counter proposals typically using the same parameters used to specify the incoming proposal (they are equivalent In that they have the same or a sumilar utility). Thus in the example given above, the iso-contour generator will take a single parameter value and unpack it to produce one or more counter proposal having price, delivery time and quality values. The iso-contour generator is then able to compare the unpacked counter proposals with the incoming proposals and pass these back into the negotiation via a proposer 10 if they have the same or similar (within a predetermined margin or margins) values for the parameters under negotiation. This function may be carried out by the proposer 10.

The proposer 10 (which is market mechanism specific) outputs one or more proposals (depending on the negotiating requirements for the negotiation and on the number of proposals which the iso-contour generator has determined sufficiently match the incoming proposal sufficiently well).

It will be appreciated that if, for example, the negotiating mechanism allows disjunctive proposals then it is the function of the proposer 10 to supply the multiple counter proposals in the form of a single counter proposal expressing the multiple proposals disjunctively. Alternatively, the proposer may select which counter proposals to supply using criteria such as closeness to incoming proposals or on a random basis.

It will also be appreciated that the cycle of negotiation is then likely to be repeated since the counter proposal will be processed by one or more negotiating agent acting on behalf of others of the negotiating parties. Thus further counter proposals from the other agents are to be expected as new incoming proposals to the proposal assessor 2. The cycle will continue until either withdrawal is indicated by the negotiating strategy or until a proposal is accepted.

1. A method of negotiating comprising:
(i) receiving a multi-parameter proposal expressed using a plurality of negotiable parameter values,
(ii) processing the multi-parameter proposal using a predetermined mapping process to produce a single value representative of the plurality of negotiable parameter values,
(iii) processing the said single value in accordance with a predetermined single parameter negotiating strategy, and
(iv) returning the output of the single parameter negotiating strategy.

2. A method according to claim 1, including providing a process for processing the multi-parameter proposal as a separable module.

3. A method according to claim 1, wherein the output of the single parameter strategy is an acceptance Indication which indicates that a particular single value representation of a multi-parameter proposal is acceptable.

4. A method according to claim 1 wherein the output of the single parameter strategy Is a withdrawal Indication which indicates that a withdrawal from the negotiation should be effected.

5. A method according to claim 1, wherein the output of the single parameter strategy is a single value representative of a counter proposal, the method further including processing the single value counter proposal to produce a multi-parameter counter proposal having a plurality of negotiable parameters which are equivalent to the plurality of negotiable parameters used to express the originally-received proposal.

6. A method according to claim 5, further including comparing the multi-parameter counter-proposal with a plurality of received multi-parameter proposals and determining for which received proposals, the counter proposal is different by less than a predetermined margin.

7. A method according to claim 1 wherein the pr determined mapping process is arranged to take account of data provided by the issuer of the multi-parameter proposal which is provided separately from the multi-parameter proposal.

8. A method according to claim 1, including providing the predetermined mapping process as a separable module.

9. A method according to claim 8, wherein the output of the single parameter strategy is an acceptance indication which indicates that a particular single value representation of a multi-parameter proposal is acceptable.

10. A method according to claim 8 wherein the output of the single parameter strategy is a withdrawal indication which indicates that a withdrawal from the negotiation should be effected.

11. A method according to claim 8, wherein the output of the single parameter strategy is a single value representative of a counter proposal, the method further including processing the single value counter proposal to produce a multi-parameter counter proposal having a plurality of negotiable parameters which are equivalent to the plurality of negotiable parameters used to express the originally-received proposal.

12. A method according to claim 11, further including comparing the multiparameter counter-proposal with a plurality of received multi-parameter proposals and determining for which received proposals, the counter proposal is different by less than a predetermined margin.

13. A method according to claim 8 wherein the predetermined mapping process is arranged to take account of data provided by the issuer of the multi-parameter proposal which is provided separately from the multi-parameter proposal.

14. A method according to claim 8, including providing the process for processing the multi-parameter proposal as a separable module.

15. A method according to claim 14, wherein the output of the single parameter strategy is an acceptance indication which indicates that a particular single value representation of a multi-parameter proposal is acceptable.

16. A method according to claim 14 wherein the output of the single parameter strategy is a withdrawal indication which indicates that a withdrawal from the negotiation should be effected.

17. A method according to claim 14, wherein the output of the single parameter strategy is a single value representative of a counter proposal, the method further including processing the single value counter proposal to produce a multi-parameter counter proposal having a plurality of negotiable parameters which are equivalent to the plurality of negotiable parameters used to express the originally-received proposal.

18. A method according to claim 14 wherein the predetermined mapping process is arranged to take account of data provided by the Issuer of the multi-parameter proposal which is provided separately from the multi-parameter proposal.

19. A method according to claim 18, further including comparing the multiparameter counter-proposal with a plurality of received multi-parameter proposals and determining for which received proposals, the counter proposal is different by less than a predetermined margin.

20. A method according to claim 10, wherein the output of the single parameter strategy is a single value representative of a counter proposal, the method further including processing the single value counter proposal to produce a multi-parameter counter proposal having a plurality of negotiable parameters which are equivalent to the plurality of negotiable parameters used to express the originally-received proposal.

21. A method according to claim 20, further including comparing the multiparameter counter-proposal with a plurality of received multi-parameter proposals and determining for which received proposals, the counter proposal is different by less than a predetermined margin.

22. A method according to claim 20 wherein the predetermined mapping process is arranged to take account of data provided by the issuer of the multi-parameter proposal which is provided separately from the multi-parameter proposal.

23. A method according to claim 2, including providing the predetermined mapping process as a separable module.

24. A method according to claim 11, further including comparing the multiparameter counter-proposal with a plurality of received multi-parameter proposals and determining for which received proposals, the counter proposal is different by less than a predetermined margin.

25. A method according to claim 24 wherein the predetermined mapping process is arranged to take account of data provided by the issuer of the multi-parameter proposal which is provided separately from the multi-parameter proposal.

26. A method according claim 12 wherein the predetermined mapping process is arranged to take account of data provided by the issuer of the multi-parameter proposal which is provided separately from the multi-parameter proposal.

27. Negotiating apparatus comprising:
(i) a proposal assessor arranged to receive a multi-parameter proposal expressed using a plurality of negotiable parameter values,
(ii) a preference mapper arranged to process the multi-parameter proposal using a predetermined mapping process to produce a single value representative of the plurality of negotiable parameter values,
(iii) a strategy processor arranged to process the said single value in accordance with a predetermined single parameter negotiating strategy, and
(iv) a negotiation output arranged to return the output of the strategy processor.

28. Apparatus according to claim 27, wherein the output of the strategy processor is a counterproposal and wherein the apparatus further comprises a contour generator arranged to receive a single parameter negotiation proposal from the strategy processor, to pass the received single parameter negotiation proposal to the preference mapper, the preference mapper being further arranged to unpack the single parameter negotiation proposal into a multi-parameter proposal representative of the single parameter proposal and to return the unpacked proposal to the contour generator.

29. Apparatus according to claim 27, wherein the strategy processor is arranged to be a replaceable module, whereby the negotiating strategy of the apparatus may be altered.

30. Apparatus according to claim 29, wherein the output of the strategy processor is a counterproposal and wherein the apparatus further comprises a contour generator arranged to receive a single parameter negotiation proposal from the strategy processor, to pass the received single parameter negotiation proposal to the preference mapper, the preference mapper being further arranged to unpack the single parameter negotiation proposal into a multi-parameter proposal representative of the single parameter proposal and to return the unpacked proposal to the contour generator.

31. A proposal assessor arranged to receive a multi-parameter negotiation proposal expressed using a plurality of negotiable parameter values, the proposal assessor further comprising a mapping output arranged to output the multiparameter proposal to a mapping means for mapping the multi-parameter proposal to a single parameter proposal, a mapping input arranged to receive a single parameter proposal from the said mapping means, and a utility score output arranged to output a utility score representative of the multi-parameter proposal for processing by a single-parameter strategy process.

32. A contour generator arranged to receive a single parameter negotiation proposal, the contour generator including a mapping output and a proposal input, the contour generator being further arranged to pass a received single parameter negotiation proposal to the mapping output and to receive an unpacked multi-parameter proposal representative of the single parameter proposal via the proposal input.
